(19) United States
(12) Patent Application Publication
(10) Pub. No.: US 2008/0266593 A1
(43) Pub. Date: Oct. 30, 2008

(54) Image document creation

(76) Inventors: Jose Abad Peiro, Sant Cugat (ES); Jan Morovic, Colchester Essex (GB); Rafael Goma, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,941

(22) Filed: Apr. 30, 2007

(51) Int. Cl. G06K 15/02

(52) U.S. Cl. 358/1.15

(57) ABSTRACT

Embodiments for creating image documents are disclosed.

In the fields of printing and imaging technology, the protection and print quality of printed materials are often left to the creator or user to implement and/or adjust. With respect to digital rights protection, many created images have no protection whatsoever when they are created because the creator does not know how to implement such protections or these protections are not respected, or removed. In some instances, this allows others to use the content created without compensation to the creator. When widely disseminated, this can result in a loss of uniqueness of the content created and a loss of potential revenue from sales of the content, among other issues.

With respect to print quality, it is often difficult for a non-professional printer to be able to reproduce a print with similar quality from one print to the next or from prints on one device to another. For example, when digital images, such as photos are created, the creators typically print to their local printers in a way where every print action is a different and independent one.

In such instances, each time a printout is made there are a number of decisions to make such as what type of computing device was used to create the image, what type of computing device is going to be used to initiate the print job, the type of printing device that was used to create an initial print (if any), the type of printing device that is to be used to print a current print job, the operating system and/or application that was used to create the image document, and various document settings, among other factors. In many instances, the implementation of these similar setups that are made at different locations will likely produce different results, even if the same original with the same set of print options was used in each different place.

This can be the result of several factors including the natural variability of each context that will most likely result in different printouts. In this way, reproducing an original in two different places becomes such a complex task that businesses for proofing and pre-press work have been created to focus on achieving such print quality with an acceptable level of accuracy. This issue can be further complicated when printing systems are of different kinds.

### BRIEF DESCRIPTION OF THE DRAWINGS

FIG. 1 illustrates a network in which embodiment of the present disclosure may be implemented.

FIG. 2 illustrates an image document embodiment of the present disclosure.

FIG. 3 illustrates a representation of potential usage of documents created in accordance with embodiments of the present disclosure.

FIG. 4 illustrates a method of creating an image document according to an embodiment of the present disclosure.

### DETAILED DESCRIPTION

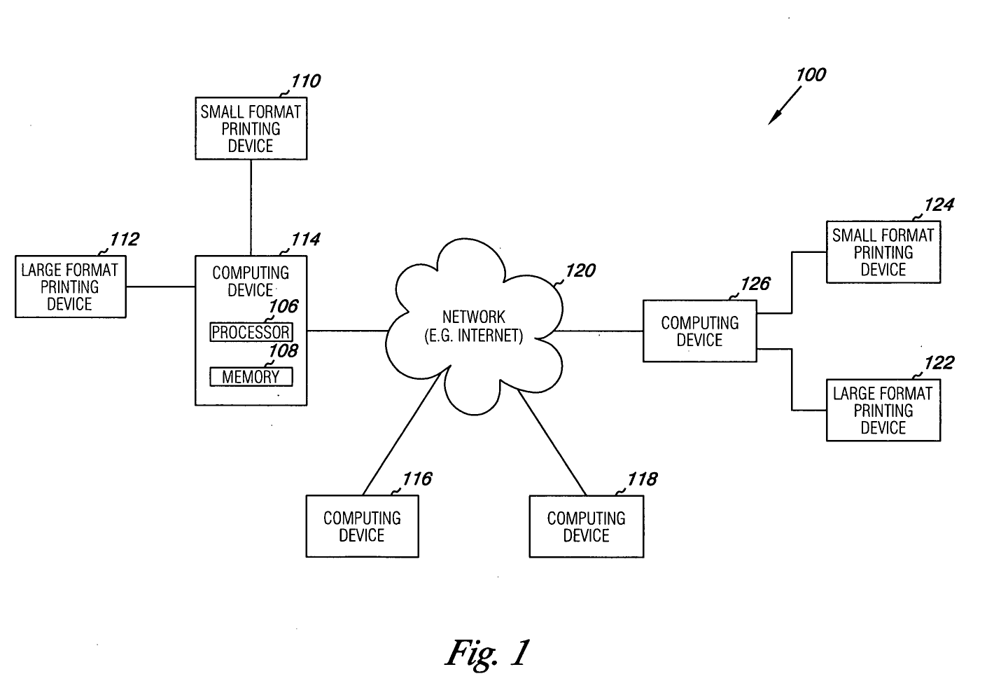

Embodiments of the present disclosure include documents, devices, and methods for creating image documents. FIG. 1 illustrates a network in which embodiment of the present disclosure may be implemented.

In the network illustrated in FIG. 1, the 100 includes a number of interconnected devices. For example computing device 114, which includes a processor 106 and memory 108, is connected to a large format printing device 112 (e.g., a professional quality, generally a high resolution type of printing device) and a small format printing device 110 (e.g., a desktop, laser, or other low cost, generally low resolution type printing device). In this example, the user of computing device 114 may be able to print both low resolution and high resolution prints based upon the connectivity of computing device 114 to both a large format printing device 112 and a small format printing device 110.

The computing device 114 is also connected to a network interface 120 through which information can be sent and received between computing device 114 and other devices of the network, such as computing devices 116, 118, and 126. For example, if the user of computing device 114 creates an image document (e.g., containing one or more images including text, photos, illustrations, and/or symbols, etc.) the image document can be sent to other users using computing devices 116, 118, and/or 126. If the image document includes digital rights management provisions, the functionalities of the other user's device may be restricted. In this way, the creator of the image document (i.e., user of computing device 114) can retain control over the use of the image document.

In the network illustrated in FIG. 1, the users of computing devices 116 and 118 are not connected to either a large format printing device or a small format printing device and, therefore, do not have the ability to print the image document. However, if the image document includes pointer information, i.e., a link to a remote version of the document which contains associations to services and details on the rights and their management, then the user of computing device 116 can be directed, for example, to user of computing device 126 who is connected to both large format printing device 122 and a small format printing device 124.

In this way, the user 116 can obtain a print of the image document even though they do not have access to a printing device. Based upon the digital rights associated with the image document, user of computing device 126 may not be allowed to print the image document without, first, obtaining authorization from the creator.

This can be accomplished in any suitable manner (e.g., the requestor of the print job obtaining the authorization and conveying the authorization with the image document and instructions, the service provider receiving the instructions and then requesting authorization, the service provider and creator defining a blanket type authorization for printing any creator originated work, etc. These various implementations can also include one or more royalties to the creator, in some embodiments. For example, as discussed below, the image document can include pricing information and such information can be designed to include royalty amounts and/or printing costs, among other pricing amounts and/or information.

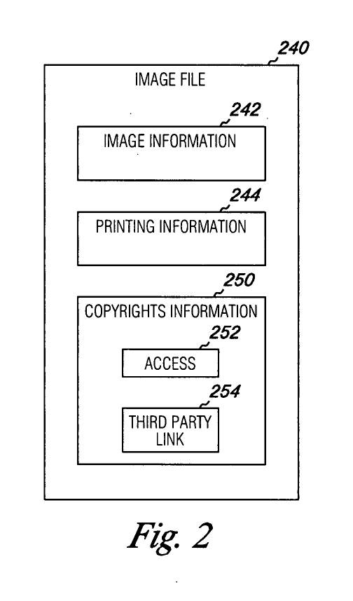

FIG. 2 illustrates an image document embodiment of the present disclosure. In the embodiment of FIG. 2, the image document (i.e., image file) 240 includes image information (e.g., image data to be used to form the image 242, printing information 244, and digital rights information (copyrights information) 250 including access information 252 and service provider information (third party link) 254. Embodiments of the present disclosure can include more or less than those elements illustrated in FIG. 2.

In some embodiments, the image information (e.g., data) can include data regarding one or more environmental conditions that were present at a time of an initial printing of the document onto a print medium.

In such embodiments, the document may then be reproduced in a more accurate manner than, in some instances where no context information from the initial printing were provided. As used herein, an initial printing may not be the first printing, but is to be interpreted as a printing that occurred prior to the printing that is about to take place.

Embodiments can utilize any suitable environmental condition and number thereof. Some examples of environmental conditions include, but are not limited to, a humidity, an ink type, a crop mark, a print layout, a printer type, a temperature, margin information (e.g., a bleeding margin), a print medium type (e.g., #20, glossy photo, matte photo), a color measurement (e.g., via a spectrometer), a print quality setting (e.g., high, low, draft, photo), a print nozzle configuration setting (e.g., nozzles used, nozzles inoperable, number of nozzles), printer status information (e.g., profiles, calibration, etc.), operating system, application, version of operating system and/or application, color engines, Raster Image Processor (RIP) engines, and/or color verification marks, among many others.

The image document can also include a set of pricing data regarding pricing of services to be performed through utilization of the image data. In such embodiments, instructions can also be provided to utilize the pricing data to inform a user via the user device about a price of a service.

For example, the pricing data can be used to inform a user, either before purchase of a service and/or after, the price for a particular service. Services such as low resolution printing, high resolution printing; or the use of the image for an imaging purpose, such as in a presentation, displaying an image as a background, icon, or as a screen saver image, among other uses.

Some services can be restricted by executable instructions as discussed below. For example, low resolution printing may be a service performed by a user on their local printing device, but that functionality may be restricted until authorization is provided to un-restrict that functionality.

Some of the above imaging functions, such as usage as a background on a display of a computing device may also be functions that can be restricted by executable instructions. The restrictions can, for example, be incorporated into the image document (e.g., access information 252) by incorporating the instructions themselves, or through use of restriction indicators, such as flag bits, that can indicate which restrictions are to be enforced and which functions are un-restricted. Accordingly, the executable instructions to enforce the restrictions and to un-restrict when authorization is provided can be resident in memory on a user computing device or another device, for example, accessible through a network.

In some embodiments, the document can also include a set of pointing data for pointing a user to a service provider (e.g., third party link information 254). In such embodiments, instructions can also be provided to utilize the pointing data to direct the user device to a service provider to provide the service.

For example, the pointing data can include an Internet address or other contact information for a service provider that allows a user to contact the service provider with regard to obtaining a desired service. In embodiments where an Internet address is provided, the user may be able to accomplish the order of a service by visiting the provider's website.

In some embodiments, a user interface can be provided that allows the user to select a service and upon selection, the service provider is automatically notified and the service can be commenced for delivery to the user. In such embodiments, the user would likely provide payment or billing information that would be communicated to the provider with the image data and instructions regarding the service to be rendered.

The document can also include a number of sets of executable instructions stored in memory of a computing device. The sets of executable instructions can, for example, be utilized to restrict a functionality of a user device, such as printing or displaying an image as a background, icon, or screen saver image, based on a set of digital rights assigned to the document.

The present disclosure also includes a number of computing device embodiments. For example, in some embodiments, the computing device can include a processor and memory having an imaging document stored therein where the print document includes instructions executable by the processor.

The executable instructions can provide a number of functions. For example, executable instructions can be used to restrict a functionality of a user device based on a set of digital rights assigned to the document. The user device can be of various types, depending upon the intended usage of the image document. For example, the user device can be a printing device, a computing device, or an imaging device.

In some embodiments, with respect to digital rights manage management when print job, for example, is generated, a unique identifier (ID) representing the creator can be embedded into the image document (e.g., PDF) in a way where the identity cannot be decoupled from the content. This ID can, for example, come from a personal certificate owned by the creator that authenticates the signature of the creator.

That same certificate can be used to hold proofs and cryptographic tokens that allow generation, modification, and/or management of the image document, related documents, and/or associated information. Use of such security mechanisms can, in many instances, be done transparently to the user, while the strength of various cryptographic methodologies can be used to preserve the security of the system. The embodiments of the present disclosure are not limit to the above restriction scheme, and accordingly, various suitable digital rights schemes may be utilized in the various embodiments of the present disclosure.

In some embodiments, executable instructions can be provided to utilize the pricing data to inform a user via the user device about a price of a service. Executable instructions can also be provided to utilize the pointing data to direct the user device to a service provider to provide the service, in some embodiments.

In various embodiments, the imaging document can be in a portable format to allow users to send and receive the document with one or more of the above described features provided therein. This allows the document to be disseminated and utilized within the defined digital rights parameters (e.g., established by the creator), and/or to be forwarded to a service provider with information that can allow for accurate printing. Such documents can be provided in a standardized format such as the Portable Document Format (PDF).

In some embodiments, PDF document is a PDF/X format document, such as PDF/X3. PDF/X3 can, for example, be used to provide a prepress standard format in combination with a spectrophotometer information. Accordingly, verification methods using the spectrophotometer in combination with algorithms that adapt the content will aid in calibrating the printing device. Such implementations can also allow color gamuts to be successfully mapped and image layouts to be preserved, among other benefits. This can be helpful for content preservation on page size independent documents.

Generally, PDF/X formats (e.g., PDF/X1, PDF/X 1-a, PDF/X2, and PDF/X3) are designed to provide the robust and flexible delivery options for PDF content data. These standards typically include that the color of all objects be expressed in CMYK (Cyan, Magenta, Yellow, and Black) or spot colors (or in PDF/X3, for example, additionally in RGB (Red, Green, and Blue), Lab color spaces, and/or tagged with International Color Consortium (ICC) profiles), and are prepared for the intended printing conditions.

All fonts to be used in the job are also to be embedded in the supplied PDF file, in many instances. PDF/X3 is standard also can include embedding of fonts, definition of overfilling, definition of page geometry, production ready image resolution, and handling of ICC profiles, among other features. The advantages of such formats include a reduction of errors in teamwork between creative and producing entities.

In some embodiments, a central storage device can be utilized for the storing of various information that may be used in the printing process. For example, initial printing device information can be retrieved either from the printing device itself, from the document, or from a central storage device (e.g., via a web-server) for use in the printing process.

In some embodiments, in order to ensure that the data is preserved correctly a set of executable instructions (e.g., a software application) can be used to bind a set of files or information (e.g., instructions and/or data) together, thereby preserving the integrity of the set together. Such binding can include contextual information about the user, the application, the project, working directories, profiles, etc.

In some embodiments, users can compose lists of print jobs and add comments and/or finishing settings to this list. Such lists can be used for a variety of purposes. For example, the list can allow the user to see the usage of their image.

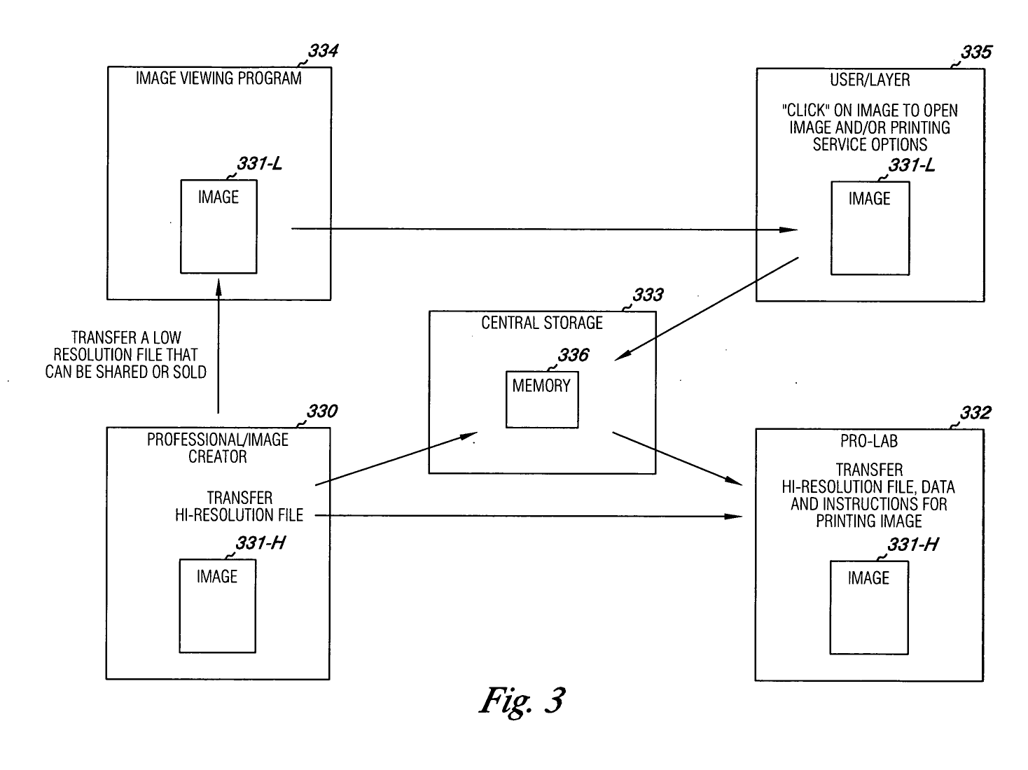

FIG. 3 illustrates a representation of potential usage of documents created in accordance with embodiments of the present disclosure. In the illustration of FIG. 3, an image document can be created (in this case as a high resolution image 331-H) by a creator (e.g., professional/image creator) 330. The creator can then choose how the image document is to be disseminated. This can be accomplished in any suitable manner, such as by sending to individuals, presenting in presentation materials, posting on the Internet or other network, among other dissemination methods.

In the illustration of FIG. 3, the image document is shown being transferred to a user utilizing an image viewing program to view the image document. In the illustration of FIG. 3, the image document provided to the user of the image viewing program is a low resolution image document 331-L and, therefore, some of the functionality of the printing and imaging of the image document may not be practical with a low resolution document.

In the embodiment of FIG. 3, if the user of the image viewing program 334 desires to print the document, a user layer (user/layer) 335 can be provided to the user of the image viewing program 334. The user layer can be designed to create a request for authorization to perform a function with the image document.

For example, the user layer can allow the user to indicate that they desire to see printing and/or imaging service options (e.g., “click” on the low resolution image to open a display window that provides the printing and/or imaging information). This information can include various suitable the types of printing options available (e.g., low resolution, hi resolution, sizes of prints, finish types, etc.).

If a high quality print is desired, in the embodiment illustrated in FIG. 3, a copy of the high resolution image document has been transferred to a central storage location 333 and has been stored in memory 336. This high resolution image document can be accessed and sent to, or accessed by a service provider (for example a professional photographic laboratory) 332 for accomplishing the high quality print request.

In some embodiments, the high resolution image document may be sent or retrieved from the creator directly, as indicated in the embodiment of FIG. 3. Through use of the hi resolution image document 331-H, the service provider 332 can have pricing, image, and printing information that can be utilized to create an accurate reprint of the image document, if the image document has already be printed previously based upon the inclusion of environmental information in the image document as discussed herein.

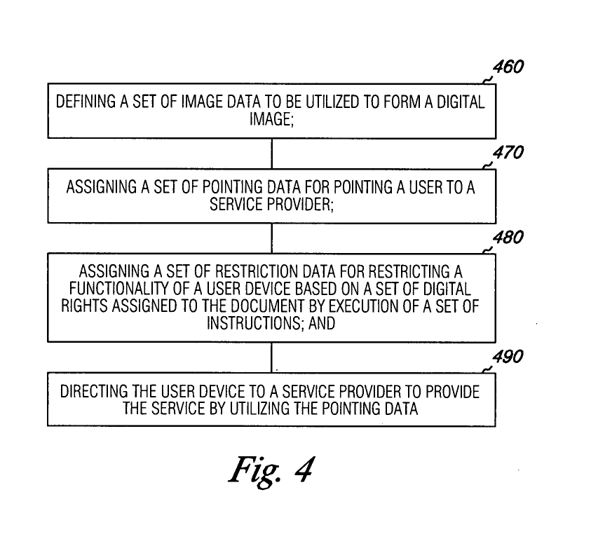

FIG. 4 illustrates a method of creating an image document according to an embodiment of the present disclosure. In various embodiments, a digital image document can be creating by defining a set of image data to be utilized to form a digital image, as described in block 460 of FIG. 4.

Such image data can be obtained from any suitable source in various embodiments of the present disclosure. For example, defining a set of image data to be utilized to form a digital image can include capturing at least some of the set of image data through use of a scanning device. Defining a set of image data to be utilized to form a digital image can, in some embodiments, include capturing at least some of the set of image data through use of a camera device.

In various embodiments, defining a set of image data to be utilized to form a digital image can include capturing at least some of the set of image data by accessing an image data file stored in memory. In some embodiments, those mentioned above and/or other locations can be utilized to provide image data.

Embodiments can include assigning a set of references to online accessible data for pointing a user to a service provider, as illustrated in block 470 of FIG. 4. The creation can include assigning a set of restriction data for restricting a functionality of a user device based on a set of digital rights assigned to the document by execution of a set of instructions.

In some embodiments such as FIG. 4, an embodiment can include assigning a set of restriction data for restricting a functionality of a user device based on a set of digital rights, as illustrated in block 480. This can, for example, be accomplished by accessing digital rights data stored in memory. In such embodiments, this accessed data can be incorporated into the image document. In some embodiments, the creator of the image can provide this data, for example, via a user interface provided through use of executable instructions (e.g., a software application, such as a desktop type program or web interface) on their computing device or other computing device.

A user device can be directed to a service provider to obtain the service by utilizing the online pointed data, in some embodiments, as discussed above and as illustrated in FIG. 4 at block 490. In such embodiments, a service can be performed based upon one or more items of information provided by the user device.

This information can be provided as instructions and/or in the form of service indicators, such as flag bits, which when provided to appropriate executable instructions, can be interpreted to indicate one or more desired services. Services can include the un-restricting of a functionality of a user device, as discussed above.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A digital image document, comprising:
a set of image data to be utilized to form a digital image;
a set of pricing data regarding pricing of services to be performed through utilization of the image data;
a set of pointing data for pointing a user to a service provider;
a number of sets of executable instructions stored in memory of a computing device to;
restrict a functionality of a user device based on a set of digital rights assigned to the document;
utilize the pricing data to inform a user via the user device about a price of a service; and
utilize the pointing data to direct the user device to a service provider to provide the service.

2. The image document of claim 1, where the pointing data includes an Internet address of a service provider.

3. The image document of claim 1, where the pricing data includes pricing for a printing functionality.

4. The image document of claim 1, where the pricing data includes pricing for an imaging functionality.

5. The image document of claim 1, where the executable instructions stored in memory to restrict a functionality of a user device restrict a print functionality.

6. The image document of claim 1, where the executable instructions stored in memory to restrict a functionality of a user device restrict an imaging functionality.

7. The image document of claim 1, where the image data includes data regarding an environmental condition that was present at a time of an initial printing of the document onto a print medium.

8. The image document of claim 1, where the data regarding an environmental condition that was present at a time of an initial printing of the document onto a print medium is selected from the group of environmental conditions including;
a humidity;
an ink type;
a crop mark;
a print layout;
a printer type;
a temperature;
margin information;
a print medium type;
a color measurement;
a print quality setting; and
a print nozzle configuration setting.

9. A method of creating a digital image document, comprising:
defining a set of image data to be utilized to form a digital image;
assigning a set of pointing data for pointing a user to a service provider;
assigning a set of restriction data for restricting a functionality of a user device based on a set of digital rights assigned to the document by execution of a set of instructions; and
directing the user device to a service provider to provide the service by utilizing the pointing data.

10. The method of claim 9, where the method includes performing the service based upon information provided by the user device.

11. The method of claim 9, where defining a set of image data to be utilized to form a digital image includes capturing at least some of the set of image data through use of a scanning device.

12. The method of claim 9, where defining a set of image data to be utilized to form a digital image includes capturing at least some of the set of image data through use of a camera device.

13. The method of claim 9, where defining a set of image data to be utilized to form a digital image includes capturing at least some of the set of image data by accessing an image data file stored in memory.

14. The method of claim 9, where assigning a set of restriction data for restricting a functionality of a user device based on a set of digital rights is accomplished by accessing digital rights data stored in memory and incorporating the data into the document.

15. A computing device, comprising:
a processor;
memory having an imaging document stored therein where the print document includes instructions executable by the processor to:
restrict a functionality of a user device based on a set of digital rights assigned to the document;
utilize the pricing data to inform a user via the user device about a price of a service; and
utilize the pointing data to direct the user device to a service provider to provide the service.

16. The device of claim 15, where the user device is a printing device.

17. The device of claim 15, where the user device is a computing device.

18. The device of claim 15, where the user device is an imaging device.

19. The device of claim 15, where the imaging document is in a portable document format.

20. The device of claim 19, where the portable document format document is a PDF/X3 format document.
